(19) United States
(12) Patent Application Publication
(10) Pub. No.: US 2004/0113817 A1
(43) Pub. Date: Jun. 17, 2004

(54) Flashing infrared beacon system

(76) Inventors: Harvey M. Novak, Crofton, MD (US); Chad Sample, Glenn Dale, MD (US); Paul R. Baity, Great Cacapon, WV (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/210,871

(22) Filed: Aug. 2, 2002

Related U.S. Application Data
(60) Provisional application No. 60/310,271, filed on Aug. 7, 2001.

(51) Int. Cl. G08G 5/00

(52) U.S. Cl. 340/983

(57) ABSTRACT

An infrared beacon includes a plurality of infrared emitters disposed on a support and a power supply providing power to the infrared emitters. The infrared beacon emits a flashing infrared signature to allow identification or classification of a target in low light conditions. The beacon may be viewed with a thermal infrared viewing device.

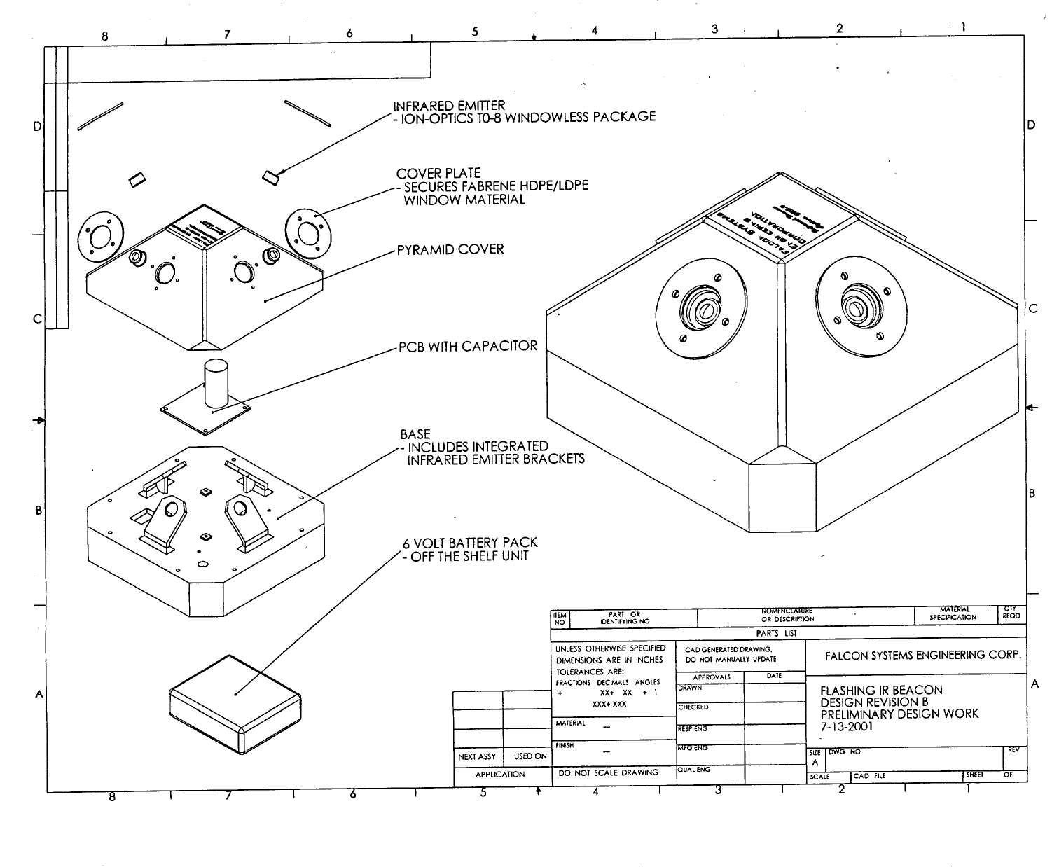

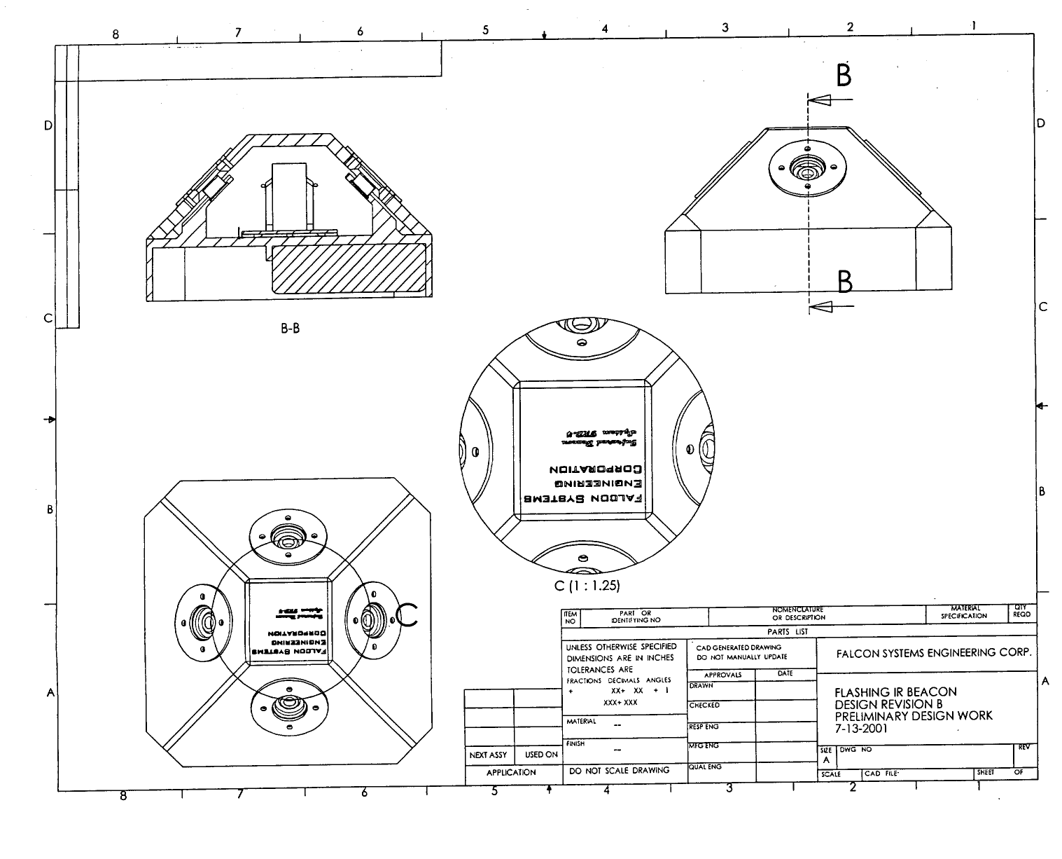

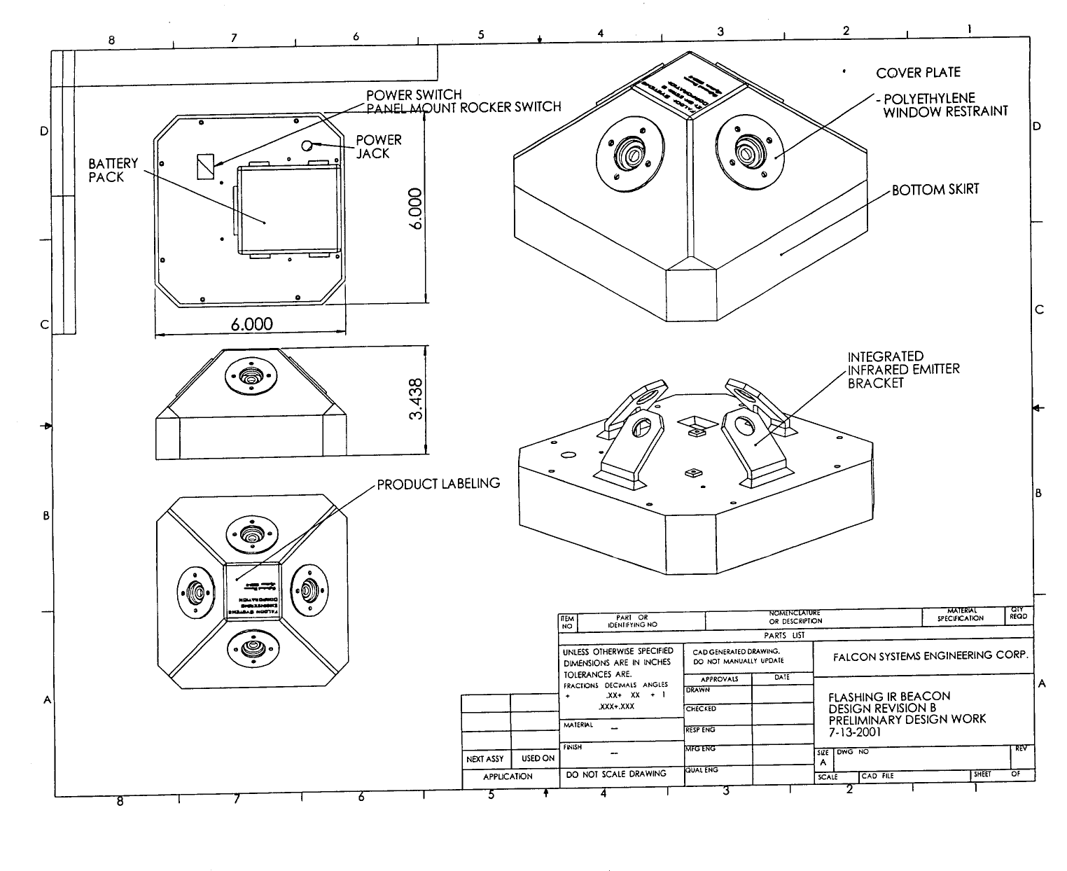

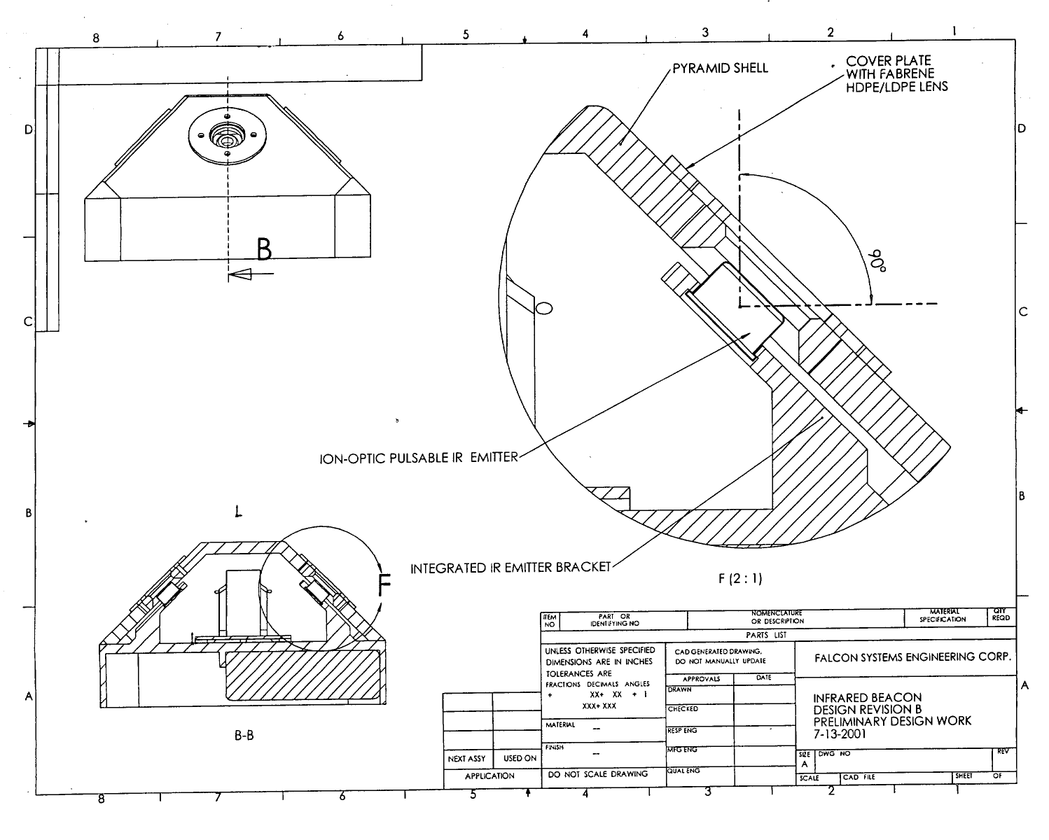

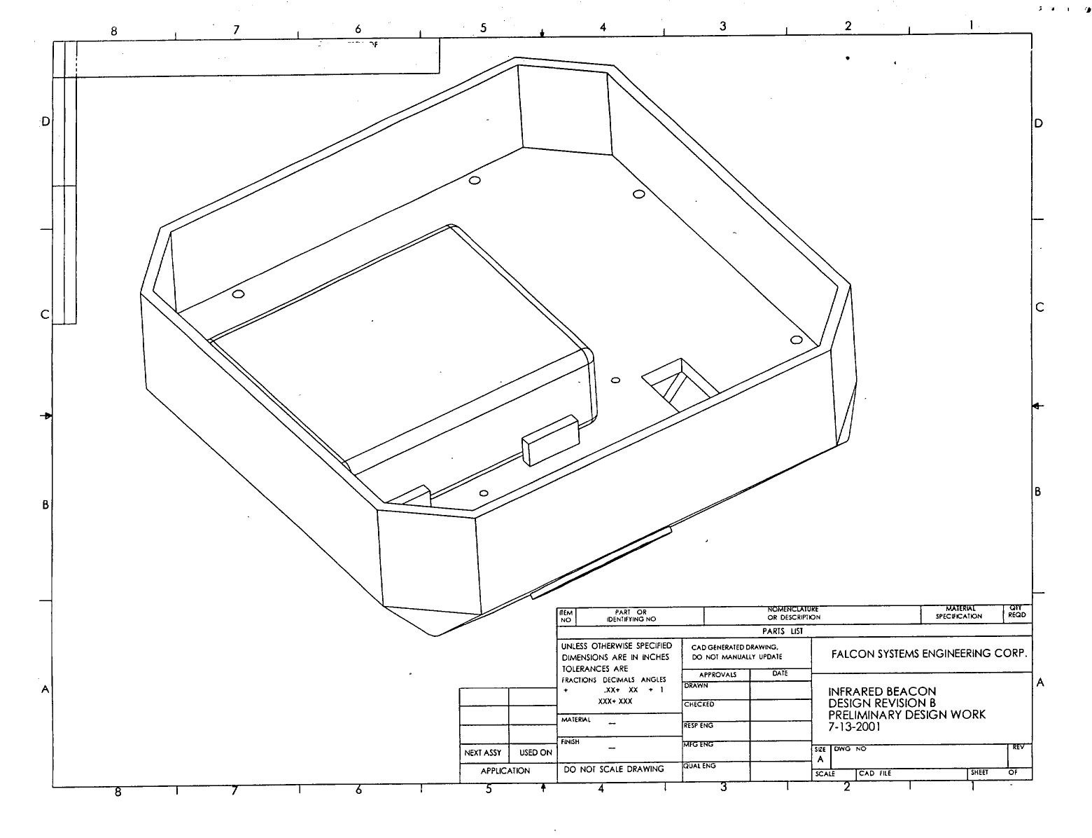

### 1.1. DESCRIPTION

The Infrared (IR) Beacon emits a unique flashing IR signature that facilitates effortless nighttime identification and classification of a distant target or location by a remote observer using a thermal IR imaging device. The optimal infrared signature is observed with mid-to-long wave infrared (thermal) sights like those mounted on Apache attack helicopters, M1A1 Abrams battle tanks, and law enforcement helicopters. The infrared beacon is easily detected and distinguished from the observed thermal environment and other nearby observed infrared signatures when using airborne infrared imaging devices. Additionally, the thermal signature generated by the beacon can also be effectively observed with handheld and rifle mount imaging equipment. Beacon emissions generated by the system are invisible to the naked eye as well as to image (low light) intensifiers and near infrared imaging equipment.

The IR beacon signature is distinguished from operational surroundings by means of an intense concentrated pulse coupled with a unique flashing sequence. When viewed through an IR imaging device the beacon signature cuts through fog, smoke, and absolute darkness to add increased operational ability. The compact beacon system lends itself to the most demanding of situations by providing a powerful and easily identifiable beacon source while remaining portable and durable. For added flexibility, additional systems may be deployed to define a zoned perimeter and can be distinguished from each other by means of a unique flashing signature.

### 1.2. THE UNFILLED NEED

Infrared (thermal) imaging products are rapidly becoming an essential aspect of visual recognition and identification among military and government organizations. The attractive aspect of infrared imaging is that it allows the user to clearly see the observed landscape in detail despite total darkness or adverse weather conditions. Thermal equipment is a tool that enables tasks such as battlefield observation by field commanders and suspect pursuit by airborne law enforcement more effective. For instance, a tactical soldier can easily detect the thermal signature of a human being and can effectively observe and pursue the person through seemingly impossible darkness or terrain.

Thermal imaging goes one step further then traditional night vision equipment and expands the human eye to see not just visible light, but the heat generated by all bodies—both living and inanimate. One inherent drawback of thermal imaging is that the bulk of the scene's distinguishable characteristics cannot be detected. For example, the ability to read a road sign or distinguish the rank on a soldier's uniform is not possible when observing a scene through an infrared device. The observer can tell there are two soldiers, but cannot determine to which army he belongs or similarly, he can see a road sign, yet cannot determine what the sign instructs him to do.

For all of its advantages, thermal imaging lacks the ability to identify and distinguish people, places, or things. This aspect is one that is taken for granted in the visual world. The ability to positively identify and differentiate objects that we see is an essential part of the visual thought process to permit a person to make sound decisions that directly affect the safety of himself and those around him.

The immediate needs for infrared (thermal) imaging devices:

The ability to distinguish people, places, and things.

The ability to rapidly deploy methods of thermal identification and recognition.

To have an effective solution that saves time, money, and most importantly—lives.

Projected solutions to these problems have traditionally been seen as total or “solve-all” systems. These proposed solutions gather information from around the user, analyze the data, and relay the information to the user in a relatively simple form of a flashing light or computer readout. They in essence take the thought process away from the human user and allow an electronic system to make the decision as to what the user is observing. These systems, in their present state, are too cumbersome to be effective. The time needed to complete the gathering of data and analytical processing of the information required by such a task is a major roadblock to the effective implementation of these solutions. To complicate matters, the projected completion of these next-generation systems is expected in roughly ten years. This leaves a large gap to fill in the thermal imaging arena during the coming decade where infrared technology will no doubt become an ever-increasing part of daily operations for both the military and law enforcement. As the infrared imaging technology progresses and is eventually implemented by more and more organizations as a standard, there lies a vast need that must be met to ensure safe and productive endeavors.

Current solutions have been on the market for nearly a decade and have developed little during that time. The thermal marker technology has not kept pace with the rapid thermal sensor development. With the present state of infrared detection equipment, there is opportunity to effectively implement a more refined thermal marking technology. For far too long, users of thermal imaging equipment have relied on outdated infrared identification makers that have failed to keep pace with the ever-expanding technological ability of infrared identification.

### 1.3. COMPETITIVE COMPARISON

Solutions currently on the market to aide in identification and recognition with thermal imaging systems are relatively few in number. Products that are currently in use with the United States Military are rudimentary in their approach to solving the problems presented by operational implementation of mid-to-far wavelength infrared imaging systems. Current products that are used for identification at night or other poor operational conditions can be placed into two distinct categories:

Night Vision Equipment

Thermal Imaging Equipment

Night vision equipment operates by amplifying visible and near infrared light. There are numerous markers and beacons that are used with these light-intensifying systems. All of which effectively assist in identification and recognition in low light conditions. Falcon's infrared beacon is designed to operate in the mid-to-long wavelength infrared spectrum, outside the range of detection of night vision equipment. Identification with thermal imaging devices is a step above and beyond night vision equipment. A few of these reasons are listed below:

The ability to operate in total darkness and adverse weather conditions.

The ability for effective daytime operation.

The lack of “blooming” or “wash out” when observing a powerful source.

Higher probability that the enemy does not have thermal imaging capability then night vision equipment.

Current competitors for the identification and recognition in the mid-to-long wavelength infrared spectrum are as follows.

Chemical heat Pouches. Chemical heat pouches, when activated, rise to extreme temperatures in order to be seen by thermal sights. The temperatures that are produced by these pouches are a safety concern and it does not allow for easy handling or use. These sources are also nonrenewable solutions for combat identification.

High power heating elements. High power heating elements are safer alternatives to chemical heat pouches, but they present their own set of complications. These products consume a massive amount of power to be effective. In order to achieve operational temperature differentials, these units are operated on AC power. This significantly limits the mobility and useful operational scenarios for these products.

No power infrared (thermally) reflective and absorbent panels. No power infrared (thermally) reflective or absorbent panels are another current product that is aimed to meet the needs of mid-to-long wave infrared identification and recognition. These technologies are based upon thermodynamic principles and require relatively precise implementation to be effective. The thermal signatures generated are highly dependent on operational conditions.

Heat flares and kerosene heaters. Heat flares and kerosene heaters are the most elementary approaches to meeting the need in infrared identification. Basic heat sources are effective in some respects, but lack operational flexibility. Heat flares specifically generate visible light as well as near infrared, both of which can be seen by night vision equipment.

Falcon's flashing infrared beacon is the next generation solution. Some general improvements over current products are:

Low power consumption to enable substantial operational run-time

Light weight and small in size

Reusable

Safe to handle

Invisible to the naked eye as well as to night vision/light intensifying equipment

Operates in nearly every operational condition

These improvements over market competition make Falcon's infrared beacon a novel and effective solution to meet the vast unfilled need in the thermal imaging market.

### 1.4. TECHNOLOGICAL CHANGE

The advancing world of infrared (thermal) imaging has brought about the need for Falcon's innovative flashing beacon to assist and facilitate real world usage of thermal imaging devices. With this change it has opened up a wide potential market for the sale of these simple, yet effective, solutions to common problems that frequently interfere with the effective use of infrared imagers in tactical situations. As the market progresses and matures, the technology will become more affordable to more users than ever before. This gradual influx of inexpensive thermal imaging systems, coupled with advancements in infrared detection technology, has presently brought about the need and demand for Falcon's flashing beacon technology. With new innovations and technological breakthroughs, Falcon's beacon will become more effective as the cameras that view them improve. These advances will lead to:

Greater distances at which the flashing infrared beacon can be identified.

Reduced power output to increase battery lifetime.

Reduction in infrared emitter size for greater portability.

Adaptation to meet specific applications.

Generally, a more effective technology.

Additionally, advances in the area of production and manufacturing will no doubt play a large contributing factor in the evolution of the flashing infrared beacon. Innovative production and manufacturing processes as well as breakthroughs in materials engineering can bring about these advancements. Benefits of a more refined and technologically advanced production method are:

Product differentiation and appealing packaging.

Increased durability for extended product lifetime and customer satisfaction.

Decreased size and weight.

Emitter efficiency will increase.

Overall product performance will increase.

Within the advances in technology that will aide in the progression of the infrared emitters, there lies an advantage for the development of alternative solutions to meet the same need. As new infrared detection systems are developed, the change must be matched with an active adaptation and evolution of Falcon's products to keep pace with these changing technologies. Though advancement of technology does require the product development of the infrared emitters to continue, it does not stand as a harbinger of obsolescence for Falcon's flashing beacon system. Technological change will only bring about further product developments and innovations for Falcon Systems Engineering Corporation.

### 1.5. SPECIFICATIONS

Flashing thermal signature.

Detectable out to distances of 1 to 1.5 miles.

Broadband infrared emission (2-20 microns). Thermal signature viewable with any IR scope, FLIR, etc. regardless of infrared frequency band.

Generates total hemispheric emission coverage. Thermal signature viewable from any approach angle.

Emits little to no visible light or near infrared.

Beacon Emission does not affect observer's night vision.

Light weight—less than 5 pounds including a battery pack.

Small in size for easy transport and storage.

Durable and rugged.

Battery pack runtime of 10 hours.

Rapid charging of battery source with AC adapter, car adapter, or external battery source.

### 1.6. APPLICATIONS

The flashing infrared beacon's primary objective is to save the lives of our military, law enforcement and emergency response personnel through the use of Falcon's infrared identification technology. This device will help reduce fratricide (friendly casualties due to friendly fire). To do this, the infrared beacon produces a unique and distinguishable thermal signature that facilitates effortless identification when using a mid-to-long wavelength infrared imaging device. This unique thermal signature can be used to differentiate multiple persons, vehicles, and landing zones. Falcon's infrared beacon can be used in a variety of situations with various operational parameters. Some of the basic situations where infrared identification devices can be implemented are as follows:

Identification of friend or foe (IFF).

Landing zone identification for military, law enforcement, or rescue operations.

Landing zone identification for medical evacuation helicopters.

Personnel or mobile unit identification.

Trail markers.

Road signs.

Undercover police operations.

SWAT team operations.

Emergency evacuation beacon for downed airmen.

Safety (no-fire) zone identification.

Sea and coastal rescue operations.

Life rafts and life vests.

Fire rescue.

### 1.7. EMBODIMENTS

### 1.7.1. Preferred Embodiment

### Physical Description

The preferred embodiment of the Flashing Infrared Beacon takes the form of a four (4) sided pyramidal shape. The beacon assembly consists of:

Pyramid Emitter Housing

Four Low-Density Polyethylene lenses and lens covers

Pyramid base assembly with integrated emitter mounting brackets

Four pulsable broadband infrared emitters

Power switch, drive selector interface, and power input jack

Control electronics

Rechargeable battery pack

Mounting accessories

[image]

The housing is constructed of durable plastic or composite material that provides excellent strength and durability. Additionally, the housing is fastened together by means of standard machine screws to allow for a tight and secure fit. All mating joints have flanges and grooves to prohibit water, dust, or other containments from penetrating the outer shell of the beacon. The overall size of the beacon is six inches square at the base and approximately 3 inches in height. These small dimensions facilitate easy transport and deployment.

Each side of the beacon pyramid is 45 degrees off the horizontal and houses a single pulsing infrared source. This angle provides the maximum emission coverage when the beacon is activated. The output emission coverage is 360 degrees in the azimuth and 180 degrees in elevation. The output from each individual emitter forms a cone of 90 degrees where the emission is no less than 50% of the maximum emission produced by the emitter. Representative diagrams of beacon infrared emission can be seen in the following drawings.

[image]

The above diagram is a side view from ground level of the infrared beacon. The orange cones denote areas of infrared emission that are at least 50 percent of maximum emitter intensity. Overlap of combined emission intensity can be seen in with darker shades of orange. Total coverage in elevation is near 180 degrees.

[image]

The above diagram represents the infrared beacon from a viewing angle directly above the system. Orange cones denote areas of intensity that are observed to be no less than 50% of maximum intensity. Overlap of combined emission intensity can be seen in with darker shades of orange. Total azimuth coverage is 360 degrees.

[image]

The above pictures simulate the thermal signature of a mobile Humvee unit equipped with a Falcon infrared flashing beacon. The picture on the left shows the Humvee when the beacon is between flashes. The picture on the right depicts the thermal signature (highlighted with a red arrow) produced by the Falcon Infrared Beacon when at full flash intensity.

To provide cover and to insulate the infrared source, a lens of low-density polyethylene sheeting is placed over the infrared emitter and is secured in place by means of a cover plate, which is screwed to the beacon housing. The primary purpose of the low-density polyethylene window lens is to provide insulation and protection to the emitter elements. This lens is nearly 80% transparent to the infrared emissions generated. This is an essential aspect of the design to allow maximum infrared radiation to reach the intended observer with minimal attenuation.

The base of the pyramid is the main chassis of the beacon system. Attached to base of the unit are:

The PCB containing the control electronics

The four pulsable broadband infrared emitters

The rechargeable battery pack

The power switch, jacks, and user interface

The base is made constructed of the same material as the pyramidal housing. To provide secure mounting points for the control PCB, a series of standoffs are molded into the base constriction. These standoffs are tapped to allow for standard machine screw attachment without the need for nuts. In addition, four molded mounting brackets to house the infrared emitters are formed into the base assembly as well. These integral angle brackets run parallel to the face of the pyramid housing and secure the infrared emitters in place by means of a slipping the emitter housing through the mounting hole and applying some heat resistant adhesive. These brackets keep the emitter in place and recessed from the face of the pyramidal housing enough to limit damage, but do not interfere with the 90 degree emission cone from the emitter. The rechargeable battery pack is also attached to the base of the unit by means of a mechanical attachment such as a bracket and screws or Velcro straps. The ideal battery pack has a nickel metal hydride chemistry and provides ample voltage and capacity to allow for extended run-times. Target voltages for the battery packs are standard 6-volts and 9-volts to facilitate rapid procurement. Finally, the power switch, jacks, and user interface are mounted on the bottom side of the base and protected by a molded skirt. This skirt protects the power switch and other user interfaces from being activated by accidental contact with the surface that the beacon is placed on.

Four pulsable broadband infrared emitters are located on each side of the pyramid housing. Ion Optics, Inc. of Waltham, Mass., produces the emitters under the model number MSL-NL8LNC. They are mounted in place by means of integrated mounting brackets that are formed into the pyramid base. These mounting brackets securely restrain the emitters to protect against vibration and shock. During operation, the outside surface of the emitter housing rarely reaches 80 degrees Celsius and therefore does not pose a threat to deform the molded plastic mounting brackets. The emitter filament faces outward towards the low-density polyethylene window lens secured on the pyramid housing by the cover plates. The emitters are connected to the control electronics by means of small twisted pair of cables.

A power switch, drive program selector interface, and power input jack are accessible from the bottom side of the beacon. The power switch informs the user of functional status (on/off) by means of simple markings or indicators that do not produce any visible light or audible sound. The drive program selector interface allows for user-defined operation of preprogrammed infrared emitter drive functions. The power jack is a standard power input jack that accepts multiple types of power sources. This jack permits the beacon to run independently of the integrated rechargeable battery pack as well as the ability to recharge the onboard nickel metal hydride cells. The power switch and user interface are all weather resistant to prevent any outside containment from entering the beacon assembly.

The PCB attached to the base section of the beacon contains the control and drive electronics for the beacon system. The board controls the pulse frequency, duty cycle, and temperature of the four infrared emitters. The board is secured into place by means of machine screws that are inserted into threaded standoffs molded into the base of the pyramid. The PCB also incorporates power input and power output connectors to interface between the rechargeable battery cell and the infrared emitters.

The rechargeable battery source for the beacon system is within the entire assembly. The chemistry for the battery is nickel metal hydride. This chemistry allows for rapid recharge, optimum discharge characteristics, and little to no recharge memory effect to eliminate battery conditioning.

In addition to the basic emitter design that is intended to be placed on a flat level surface, mounting accessories provide for numerous mounting possibilities. These mounting options are essential to secure the beacon in a variety of operational situations. The secure placement and implementation of the beacon system will ensure proper operation and effective results. All options for mounting are integrated within a specific beacon model to eliminate the after-market modification required to meet specific needs of the user. Some of the options are:

Magnetic Strips

Stake points

Integrated stand or tripod with stake points

Velcro

Bungee Straps with hooks and clasps

Threaded mount for use on standard camera tripods

Latch systems to integrate with standard military or civilian equipment (e.g. vehicle or structure mounting systems)

### Operational Description

The intended use of the flashing infrared beacon is to provide an unmistakable marker to aid in situations where thermal imaging equipment is implemented. During use the beacon will emit a flashing sequence that will elicit the attention of the viewer when observed through a thermal imaging device. The beacon will be undetectable at any reasonable distance by night vision equipment/light intensifiers. The flashing sequence will be designed to be highly identifiable in a complex thermal scene as well as optimized for enhancing the battery source lifetime. The user interface will allow the beacon user to activate the beacon and to determine, from a predefined flashing options, what flashing sequence best meets his needs. The battery lifetime will be as such to permit the beacon to be activated for periods up to 10 hours in length. This run time will fluctuate depending on which flashing sequence is selected for use.

Due to it's small size and lightweight, the beacon can effortlessly deployed and transported. Its rugged design allows the beacon to perform in even the most demanding of applications. The slim design also lends itself to situations where weight is at a premium, such as paratroop operations and long term infantry maneuvers.

### Functional Decomposition

The emitters themselves are small metallic T0-8 package size units approximately 0.45 inches in diameter with two wire leads protruding from the bottom side. The front of the package has an opening through which the emissions generated by the filament can radiate. The thin electrically resistive filament, to increase emissive surface area, is constructed into a serpentine arrangement inside the package housing. The element is supported by two wire stand offs that double as the positive and negative terminals. The manufacturer of the infrared emitter, Ion Optics, Inc. of Waltham, Mass., describes the filament technology on their product website:

“The emissivity of these metal filament infrared sources is enhanced and controlled by creating random surface texture (sub-micron scale rods and cones). This texture modifies the reflection and absorption spectra relative to that for a flat filament of the same material. For wavelengths small compared to the feature sizes, the surface scatters most incoming light, therefore it has low reflectivity (the filaments appear visibly black), and by Kirchoff's law, it must also have high emissivity (>80%). For wavelengths long compared to the feature sizes, the surface still looks like flat metal and it therefore has low emissivity, characteristic of the flat metal (£ 0.1)”. Source: www.ion-optics.com

Driving the emitters is the control electronics housed on the PC board. This control system functions as the nerve center for the beacon. The PCB accepts power from the rechargeable battery source, external power sources (DC), as well as communicates with the user interfaces. The control electronics also drive the flashing infrared emitters and control the drive characteristics of the beacon. This encompasses the pulse frequency, duty cycle, and emitter temperature. These options can be selected by the user in the form of predetermined program inputs such as high power output schemes for use in complicated thermal environments or different flash sequences to differentiate separate flashing infrared beacons. Additionally, the drive controls can be factory defaults and the user will have little to no control over the flashing sequence and characteristics. The following functional block diagram details the system structure of the control electronics of the flashing infrared beacon.

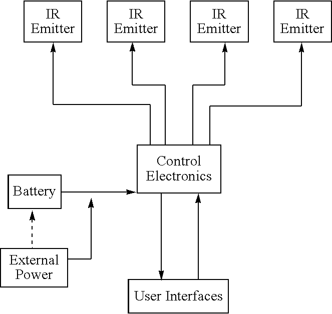

The flashing infrared beacon is powered by a rechargeable battery pack with nickel metal hydride chemistry. This chemistry allows for:

Excellent discharge characteristics.

Long battery life.

Rapid recharge capabilities.

Trickle charge capabilities.

No battery memory effect to eliminate the need for battery conditioning.

The beacon can also be powered by external power sources of various DC output. The sources are connected to the beacon through a standard power jack input. These external power sources can also recharge the battery in conjunction with operating the beacon at full power.

### 1.7.2. Secondary Embodiments

### Physical Variations

The ideal embodiment of the flashing beacon system does have areas where the specific design aspects can be changed to meet different needs or design criteria. Some variable aspects of the physical design are outlined in the following description:

Material Used for Beacon Housing Construction:

Injection molded plastic of varying chemistries to meet specific design requirements of strength and durability.

Stereo Lithography rapid prototype nylon or glass filled nylon based resin.

Composite materials.

Aluminum, titanium, or any metallic alloy.

The low-density polyethylene window material can be either an industrial synthetic fabric, solid sheet, or mesh material.

The infrared transparent window can be constructed of any infrared transparent material, which includes, but is not limited to:

Silicon

Diamond

Germanium

Calcium Fluoride

Sapphire

No window material

The control electronics can also be applied to a flex circuit base or integrated within the beacon structure itself.

Size and Shape:

The beacon can be manufactured to a variety of sizes and shapes to meet specific needs.

The ideal embodiment of a four-sided pyramid structure can be scaled to make a more compact or larger device.

The device structure can be based upon a sphere or hemisphere with emitters placed around the device to provide for ample emission coverage.

The device can have any number of sides or facets and can incorporate any number of infrared emitters.

The flashing infrared emitters can be placed in the quadrants of a hemispheric retro reflector design.

The device can incorporate multiple emitters on any one facet or face.

The device can be decreased in weight as technology and design permit.

Accessories:

The base of the beacon can incorporated multiple attachment methods to secure the beacon to any number of surfaces or objects.

Alternate power supply cables and power plugs and jacks.

Durable and weatherproof transport case.

A battery compartment to hold disposable battery cells (alkaline cells) and to allow rapid replacement of fresh batteries.

A retro reflector to add a secondary passive marking system to the flashing infrared beacon.

### Operational Variations

The flashing infrared beacon has the ability to incorporate numerous operational variations. Among these variations is the short list of general applications for the beacon system as outlined in section 1.6. The beacon system can be implemented to any number of applications to meet a desired need. To accomplish this task, there are variations upon the ideal embodiment that would allow the beacon to be tailored to meet the needs of individual applications. Some of the operational variations for the flashing infrared beacon system are:

Multiple flashing patterns that are either default factory settings, selected by the user from a predetermined set of alternate patterns, or user defined through the user interface.

The user interface can be:

Simple rotary selector dial or multi position switch.

Slide switch to set variable flash rate.

Analog character display with user input buttons.

Digital LCD display with user input buttons.

Infrared or RF data link to portable/handheld computer, laptop computer, or any other computer system.

A tap sync button to easily set the beacon flash rate.

### Functional Variations

The primary embodiment of the flashing infrared beacon is based upon the flashing infrared emitters developed by Ion Optics of Waltham, Mass. Various suppliers produce and develop pulsable infrared emitters. One such alternate source of infrared emitters is Cal Sensors of Santa Rosa, Calif. with their SVF series of pulsable emitters. Alternately, the infrared emitter technology can be developed specifically for the flashing infrared beacon system by existing suppliers or by Falcon Systems Engineering Corporation. These custom emitters would intend to enhance the performance of the beacon system and to cut cost. Some of the methods by which the infrared emitter can be changed to form secondary embodiments of the infrared beacon system are:

Deceased dimensional tolerance than what is currently produced by the beacon manufacturers.

A more unrefined or simplistic filament technology.

Larger emitter surface area.

Emitter construction that incorporates several small filaments to compose a larger emitter.

Alternate materials used for emitter construction.

Also, the battery technology can be changed to meet specific requirements for both the user and the design specifications. New battery technologies can be integrated into the beacon to improve the performance and physical dimensions as the technologies are developed. The beacon can be powered by either rechargeable or disposable battery sources. Alternate battery sources that can be used to power the flashing infrared beacon are:

Nickel Cadmium

Zinc Air

Lithium

Lithium Ion

Lead Acid

Alkaline

Ultra Alkaline Chemistries

### 1.7.3. Accessories

Associated with the flashing infrared beacon system, there are a variety of accessories that can enhance the usage of the product. Some of the added accessories are:

Wall mount AC adapter unit to recharge the integrated battery source or to power the unit independent of the built-in battery supply.

Car cigarette 12-volt adapter to recharge the integrated battery source or to power the unit independent of the built-in battery supply.

Power Harness extension. This accessory allows for connection to a 12-volt car battery as well as enough length to easily route the cable through the vehicle.

What is claimed is:

1. An infrared beacon comprising:
a support;
a plurality of infrared emitters disposed on the support; and
a power source providing power to the infrared emitters.
